(19) United States
(12) Patent Application Publication
(10) Pub. No.: US 2008/0171495 A1
(43) Pub. Date: Jul. 17, 2008

(54) Micro-Sanding Machine With A Sanding Effect By Air Disc-Abrasive

(76) Inventors: Martine Diat, Vigneux De Bretagne (FR); Christian Diat, Vigneux De Bretagne (FR)

Correspondence Address: YOUNG & THOMPSON, 209 Madison Street, Suite 500, ALEXANDRIA, VA, 22314, US

(21) Appl. No.: 11/885,864

(22) PCT Filed: Mar. 6, 2006
(86) PCT No.: PCT/FR06/00499

§ 371 Date: Sep. 7, 2007

(30) Foreign Application Priority Data
Mar. 7, 2005 (FR) 0502238

(51) Int. Cl. B24C 5/04; B24C 7/00; B24D 17/00; B05B 3/02; B05B 7/00

(52) U.S. Cl. 451/102; 239/224

(57) ABSTRACT

A pneumatic sanding machine for cleaning and scraping replaces a sanding disc with a high pressure compressed air disc swirling powder abrasive. Acceleration and ejection functions of the sanding nozzle are dissociated in two portions, allowing very thin ejection ports, even smaller than 400 micrometres in diameter, without clogging. The nozzle acceleration channel common to all ejection ports emerges on an anti-splash cone that bursts the jet of compressed air/abrasives exiting the nozzle, directing the air-abrasive flux towards tungsten carbide ejection members. Thus, the ejection ports are holes/slots drilled in tungsten carbide boards inserted in a disc/platen. The disc/platen may be driven to rotary speeds (RPM) obtained using a mini-turbine of 1,000-20,000, possibly exceeding 30,000, but generally 4,000-12,000, enabling high pressure work. The weight, space and manoeuvrability allow the tool to be directly adapted on the arm of an industrial robot and sanding aircraft flight deck and automotive bodywork, etc.

The present invention relates to a pneumatic micro sanding machine with a sanding effect by air disc-abrasive. The fields of application of the present invention are: dermatology, cleaning thin polychromies and very fragile sculptures and any other fields requiring the finest possible cleaning of micro-pellicular deposits.

There exists already in dermatology a skin abrasion method called microdermabrasion. This method consists in digging into the superficial layer of the skin par mini-sanding. This method consists in projecting using a compressor compressed air loaded with abrasives in the form of powder. These abrasive powders are in fact corundum or alumina oxide micro-crystals, highly angular and of size distribution often smaller than 50 microns. These abrasives are projected at very low pressures of the order of approximately 1 to 2 bars, through a small nozzle of approximately 1 millimetre in diameter. The effect sought by the action of this mini-sanding is to eliminate the pellicular surface layer of the skin in order to stimulate the production of new cutaneous cells, in order to force the epiderm to regenerate.

But the current results are much mitigated. Indeed this mini-sanding method akin to scraping techniques for clogged buildings is not based upon sufficiently fine and regular friction of the skin, since the jet rather tends to dig into the skin, which in the case of the treatment of wrinkles causes excessive abrasion, which defeats the initial purpose.

In the field of rehabilitation appeared some ten years ago a tool using laser for scraping soots and smears covering the fragile sculptures of older edifices made of dressed ashlars. Its principle is to try to avoid any digging or degradation of the original support when cleaning the deposits of micro-soots and smears. But, the controversy about this tool is due to the fact that it can only remove highly bonded deposits by raising the temperature by several thousand degrees. The laser cleans by extremely high localised heating, in order to transform each particle of smears into a gas. The yellowing effect typical of laser cleaning would be due to the scorching of the superheated support for an extremely short period of time, since the laser emission is adjusted on the dark colour of the support. The laser emission also produces a certain number of mechanical shock waves propagating through the material. The cleaning laser belongs to class 4, its emission (LEA) is a billion times stronger than solar emission. This provides a tool requiring specialised engineers and therefore makes the usage of laser rather tricky.

It is thus that this invention intends to remedy all these shortcomings. To do so, it offers for the rehabilitation of monuments, in dermatology and any other industrial fields requiring ultra-fine sanding, a new tool which is particularly efficient, easy to operate, simple and convenient in its use.

The tool of the present invention is in the form of a pneumatic micro-sanding machine. But it cleans without any abrasive discs. The sanding disk made of sand paper, corundum, alumina oxide, or other abrasives usually fitting a conventional sanding machine is replaced with a high pressure compressed air cushion acting as a disc and which is loaded with corundum, alumina oxide, etc.

The applicant will remind of its research works which are already the subject of patents based on sanding and micro-sanding techniques:
Sanding consists in projecting, under compressed air, using a nozzle, sand onto a support to be scraped. Sanding is a particular corrosive method. To do so it is known to replace high size distribution sand, close to 2 millimetres, with abrasive in the form of powder of size distribution close to 80 to 100 micrometres, a powder which is harder and thinner. But because of the extreme brittleness of certain supports and because of the throughputs required by companies, in spite of the thinness of the powder, numerous abrasion problems persist. Consequently the applicant in his previous patents, in particular the patents FR-2 685 027 and FR-2 684 900, suggested new technical solutions for solving the problems associated with thinness and throughput. Such solutions, in order to mitigate the corrosive defect of power jet sanding, while keeping the “abrasive effect required”, consist:
1 In making the projection nozzles rotary.
2 In using nozzles whereof the acceleration channels are thin and whereof le diameter is preferably situated around 1 to 4 millimetres.
3 In using not one or two nozzles, but a multitude of acceleration conduits of nozzles (at least ten).

Even if one could obtain generally a very good result, in numerous fields of application, the numerous tests conducted by the applicant have shown that his technique was still perfectible in particular as regards the excess of dust as well as the thinness in abrasion.

The previous patents of the applicant lead, in order to increase the throughput, to multiply the number of nozzles and consequently the volume of air and abrasives, which causes a vast amount of dust and implies turning to very heavy and cumbersome suction equipment. Indeed, from a certain volume of projected air, the problem of the dusts becomes complex and requires the use of heavy and cumbersome suction means, which compromises the manoeuvrability and any high precision work for a thin scraping operation.

The most extreme thinness is required for scraping the skin efficiently by superficial friction but without attacking said skin too deeply and for reviving the colours of the lustres of totally tarnished polychromies. Still, to provide such results the obvious solution would consist in reducing the projection pressure. As well as to reduce the generation of dust, the obvious solution consists in decreasing the volume of projected abrasive. But these means have not proven satisfactorily. The technology claimed in the previous patents of the applicant does not enable to obtain the new results desired.

Moreover, with the previous patents of the applicant it was becoming difficult to use acceleration conduits of diameter lower than 1 millimetre. Similarly, it was becoming difficult to use a device with a multitude of nozzles with more than 500 revolutions per minute. Also, the weight of a material fitted with numerous nozzles, implies resorting to a load carrier articulated arm for working, especially when this device is weighted, using dust suction equipment.

The object of this invention is to remedy all these shortcomings as well as the shortcomings of the current scraping methods which are available on the market. In particular in the field of micro dermabrasion and all other industrial fields requiring ultra-fine sanding,

This invention enables to manufacture a hand-held tool. This tool is operated like a pneumatic micro-sanding machine. The sanding work takes place almost by contact, a few millimetres away from the surface to be scraped. This new tool acts as a pneumatic micro-sanding machine, whereof the abrasive disc would be replaced with a high pressure compressed air disc, wherein a projected abrasive swirls. The sanding work does not take place by the contact of an abrasive disc, as with a sanding machine, but by the contact of a high pressure of compressed air disc loaded with abrasive.

A pneumatic sanding machine for cleaning and scraping whose feature lies in that the disc or rotary platen fitting such sanding tool has one or several members of small thickness, drilled with more or less great a number of ejection ports, which may even be simple holes or simple slots, said holes or slots being intended for evacuating, after bursting against a anti-splash cone, a mixture of compressed air and powder coming from at least one nozzle acceleration duct, and in that said disc or platen which includes these ejection members is driven in rotation at very high speeds, these speeds are greater than 100 revolutions per minute, often ranging between 1000 and 20,000 revolutions per minute, and liable even to exceed 30,000 revolutions per minute, but ranging more generally between 4,000 and 12,000 revolutions per minute.

The very high rotational speeds of the platen or disc are obtained using a mini-turbine of pneumatic motor type.

The rotational axis of the disc or platen serves as a nozzle acceleration duct. But, moreover, the acceleration and ejection functions of this nozzle are dissociated in two portions. The nozzle acceleration channel is common to all the ejection ports, such as holes or slots. It emerges on an anti-splash cone intended for bursting the jet of compressed air jet and of abrasives at the outlet of the acceleration duct of the nozzle so as to direct the abrasive air flux towards ejection ports, such as holes or slots. These ejection members may then only be simple holes or slots drilled in washers or boards made of tungsten carbide then mainly fulfilling the ejection function only, these members may then be extremely thin and smaller than 400 micrometres in diameter, possibly, smaller than 100 micrometres, while avoiding any risk of clogging. These ejection members which may be in the form of washers or of boards are inserted in a disc or platen. That disc or platen, divested of the weight and the space requirements of nozzles, may thus be driven into rotation at very high speeds. These rotary speeds obtained using a pneumatic mini- turbine are excessively rapid and ranging between 1000 and 20,000 revolutions per minute and liable even in certain cases to exceed 30,000 revolutions per minute, which enables taking into account all these features, to be able to work, if needed, at high pressure. i.e. with more than 5 or 7 bars in pressure.

Thanks to its features of small weight and space requirements and thanks to its surfacing qualities by a sanding effect on air cushion loaded with abrasive powder, this hand-held tool enables to sand extremely delicate supports such as the skin epiderm, fine polychromies, very fragile sculptures and any types of more of less brittle supports. The tool may also be directly adapted on the arm of an industrial robot and ensure automatic operations such as aircraft and automotive sanding.

This new tool enables especially an operation liable to meet as closely as possible the requirements of the Charter of Venice (1964) which specifies explicitly that the rehabilitation interventions must take into account the following deontological principles which are : minimum intervention while respecting as far as possible the original materials; stability and reversibility of the rehabilitation products; rendering of the legibility of the work.

Along the same lines, it may be understood that the tool according to the invention is made for ensuring very superficial scraping of the first skin layer, without digging into it, thereby enabling the epiderm to regenerate.

The development of the method of this invention is based upon the following observations:
The previous patents of the applicant include limits. It is not possible, while projecting an abrasive to drive in rotation at more than 500 revolutions per minute, a multitude of nozzles. It is not possible either to use diameters of nozzles smaller than 800 micrometres, without clogging the nozzles rapidly. Global weight and dust problems also crop up.

Still, for obtaining more qualitative results and decreasing the volume of dust significantly, the applicant has oriented his research on the use of increasingly thin nozzle sections, which may even be smaller than 400 micrometres.

The present invention suggests in order to limit the emission of dust as far as possible and to enhance the scraping quality, to use as thin exhaust orifices as possible. These orifices may even be smaller than 400 micrometres, possibly even thinner, in certain cases, such thinness may reach 10 micrometres.

Simultaneously, in order to compensate for such high thinness of the nozzle sections, the research of the applicant have spurred him to try and drive the platen carrying the nozzles at speeds in excess of 500 revolutions per minute, in order to rotate at very high speeds, more than 1000 revolutions per minute and even at speeds of the order of 2000, 5000, 10,000, 20.000, possibly more than 30,000 revolutions per minute. But to reach as rapid speeds, the whole device based upon the previous patents of the applicant was not suitable.

Thus, in order to avoid clogging with such thin nozzles and rotate at very high speeds, the principle of the invention suggests to dissociate the acceleration and ejection functions of the nozzle into two different operations. This principle enables to use ejection ports, such as holes or slots, which are extremely thin, even smaller than 400 micrometres in diameter, as small as 100 micrometres, possibly less, without any clogging in the nozzle channel.

By dissociating the nozzle in two separated functions, all the ejection ports, have their acceleration channel in common. The acceleration channel de all the nozzles being common and placed in the centre of the tool, it serves simultaneously as a rotational axis of the disc or platen. Placed in the centre, it emerges on an anti-splash cone. This cone is intended for bursting the jet of compressed air and of abrasives when exiting the acceleration channel of the nozzle, so as to direct the abrasive air flux towards the ejection ports. These ejection ports drilled in a member made of tungsten carbide may then simply be simple holes or slots. Which parts made of tungsten carbide fitted with said ejection ports are nested in a disc or platen.

This disc or platen, divested of the weight and the space requirements of numerous nozzles, may thus be driven into rotation at very high speeds, i.e. at speeds greater than 500 revolutions per minute and ranging in average between 4,000 and 12,000 revolutions per minute, possibly more.

The first portion of the nozzle which fulfils the acceleration function is arranged upstream. It is an acceleration channel common to all the ejection ports. It is a conventional nozzle conduit of approximately 2 to 4 millimetres. It is this principle which enables to suppress the nozzles placed in the rotary disc and to replace them with washers or boards made of tungsten carbide of small thickness drilled with simple holes or slots. It is this element which enables very high rotational speeds. It also enables to use the smallest possible ejection diameters, down to 10 micrometres, without any clogging in the acceleration duct of the nozzle.

Consequently, the present invention enables, contrary to all other processes, to work at high pressure.

Due to the very small volume of projected air the present invention also enables not to make practically any dust any longer. With this principle, the air consumption and the volume of dusts decrease to a vast extent.

Indeed, 24 1-millimetre nozzles use up at 7 bars more than 2000 litres of air per minute. With washers or boards made of tungsten carbide drilled with 200-micrometre holes, la air consumption for 24 ejection ports is then only 70 litres per minute at 7 bars. Conversely, this principle of very low air consumption enables to double or to triple the volume of abrasive projected per litre of air. The present invention hence enables to project much more abrasive with much less air, and hence via the very high rotational speed of the disc, to gain in efficiency, especially when increasing the pressure and working extremely close to the support to be scraped.

With high rotational speeds and very thin ejection ports, of 500 micrometres, possibly less, new features appear. When working a few millimetres away from the zone to be treated, an air cushion will form which operates as a disc wherein the projected abrasive floats. The pressure can be increased highly, since it is not the nozzle jet which scrapes, but the abrasive air cushion. This principle which concentrates strength, thinness and flexibility enables perfect scraping, on the skin, on thin polychromies, or on any other support.

For feeding the tool with abrasive, different processes will be used:
The suction mode by Venturi will often be recommended, for its capacity to dilute the air powder mixture. The additional principle being also to use powders of size distribution highly calibrated by steps of 10 micrometres for instance.
in another case, the abrasive will be placed in a pressurised mini-vessel adapted directly on the tool or in very close vicinity of the operator. This mini-vessel will be fitted with an adjustment means enabling to open and to close the flow of the abrasive. It will be fitted in the flow portion with a very small tube easy to tighten, to enable very thin and very accurate dosage of the powder within one gram. This flexible small tube which is very supple under the effect of compressed air will also act as a vibrator, for easier flow of the abrasive. Wherein this mini-vessel may be fitted with a small pneumatic jack or a blow nozzle for draining sequentially the flow zone.

For the finest operations, the whole device makes use of a control cabinet. A two-way valve in the cabinet enables to circulate the compressed air without any abrasive constantly. The tool is fitted with a button for actuating the outlet of the abrasive of the vessel, which enables from the tool to close the supply of the abrasive sequentially and to work in delayed sequence of the supply of the powder. This principle enables moreover constant drainage of the channels during the operation. A system can be installed in the control cabinet so as to close automatically, in sequence of a few seconds, this abrasive outlet flap.

Thus, only compressed air circulates through the device, apart for certain fractions of seconds, where the abrasive is mixed with the high pressure air cushion.

The sanding tool may be defined more precisely as follows:

It consists of a rotary disc of small thickness made of Teflon, of approximately 1 centimetre screwed in a conical casing made of aluminium, steel or Teflon. The diameter of this disc or platen can be 20 millimetres and up to 250 millimetres. For building works (Tags, graffitis, sculptures), this disc has an average diameter of 110 to 250 millimetres. For industrial works, this disc has an average diameter of 80 to 140 millimetres. For microdermabrasion, this disc has an average diameter of 25 to 50 millimetres. In these discs are machined several bores enabling to insert washers or boards made of tungsten carbide. In average there are from 2 to 10 washers or boards on each disc. Each washer or board is drilled with several holes or slots. The number of holes or of slots is 2 to 4, but can be more significant. The washers are in average 12 millimetres in diameter. The boards are in average 12 millimetres in length for 10 millimetres in width. But these dimensions are not limiting.

The thickness of each ejection member is in average 2 to 3 millimetres. But this thickness may also be greater than 3 millimetres. The diameter of each hole drilled in the ejection member made of tungsten carbide is preferably 500 microns. But this diameter can also be larger up to 1 to 2 millimetres or thinner, down to 10 micrometres. It is also possible to replace the ejection holes, with slots, which will be as a matter of principle long rather than wide. And for using extremely thin slots of the order of less than a hundred micrometres, the washers or boards made of tungsten carbide, so-called ejection members, will not be machined any longer, but two halves will be assembled in a larger set of tungsten carbide.

The principle of the invention is such that the acceleration conduits of each ejection port are gathered into a common channel. The diameter of this conduit common to all the ejection ports which is also advantageously the rotational axis of the disc is preferably comprised between 2 and 4 millimetres. But it may also range like all the nozzle channels between 1 and 8 millimetres.

By dissociating the functions of the nozzles in two portions, the present invention enables vastly to make the device lighter, which becomes a hand-held tool easy to handle, like a micro-sanding machine. The very heavy portions of all the nozzles are replaced with a single nozzle conduit common to all the ejection ports. The disc can thus be less voluminous. Thanks to the reduced thickness of the acceleration conduits of the nozzles and to the reduced weight of the nozzles, this principle then allows to drive the disc or rotary platen at very high speeds, of more than 500 revolutions per minute, without any excessive vibrations, nor jamming of the device.

Thanks to this principle, the shaft of the pneumatic motor or rotational axis which transmits the rotation to the disc or platen may, if it is drilled in the direction of its length, fulfil a double function and serve as a nozzle common channel enabling to accelerate the air-abrasive mixture. The realisation of the tool of the invention takes place thus advantageously from an angle transmission adaptation part of a pneumatic motor, a part wherein the central axis of the angle transmission is drilled in the direction of its length. It serves thus as an acceleration conduit common to all the exhaust ports and as a rotational axis of the disc or platen.

Also, advantageously, the nozzle which is already fitted with two watertight bearings, by providing it with 5 thin blades, may have a double function: nozzle and rotor, and by adding flanges and a double cylinder, the assembly becomes a motor, which may drive the platen directly in rotation. The nozzle of the tool while being in the axial direction and having a thin diameter of approximately 3 millimetres can be at the same time the shaft of the motor, or in the case of a motor fitted with an angle transmission, the nozzle, while being in the axial direction and having a thin diameter of approximately 3 millimetres can also serve as the shaft of the angle transmission of a pneumatic motor.

Although the problem associated with the emission of dusts has become with the present invention, due to the very small air consumption, really a negligible problem, and the tool can be fitted with an integrated dust suction system. Since the projection disc may rotate at speeds of 10 to 20,000 revolutions per minute, it can be fitted at its periphery with plastic or aluminium vane blades connected directly to a small vacuum bag or connected to a second, more remote suction source, such as an industrial centrifugal vacuum cleaner.

Another solution consists in injecting compressed air at high speed through an annular clearance of very small width situated directly on the projection tool, in order thanks to the acceleration of air speed in the projection casing, to suck in the dusts generated. The compressed air pushed into this thin annular clearance might even come advantageously from the exhaust of the pneumatic motor which ensures the rotation of the disc or platen.

From a sanding nozzle, the invention has the following features ; the acceleration and ejection functions of this nozzle are dissociated in two portions, which enables without any clogging, in the long acceleration duct of the nozzle, to use simply at the outlet ejection members, such as extremely thin holes or slots, which might even be smaller than 400 micrometres in diameter. The nozzle channel, rotary or not, is common to all the ejection ports, it emerges on a anti-splash cone intended for bursting the air-powder mixture so as to direct it towards these ejection members, such as holes or slots. These members are arranged in more or less large number in a disc or platen and in that said disc or platen is driven in rotation preferably by mini-turbine type motorised means, at very high speeds, these speeds are greater than 100 revolutions per minute, often ranging between 1000 and 20,000 revolutions per minute, and liable even to exceed 30,000 revolutions per minute, but ranging generally between 4,000 and 12,000 revolutions per minute.

These features enable high pressure operation. Due to its small weight, space requirements and its manoeuvrability, the tool may also be directly adapted on the arm of an industrial robot and ensure operations such as sanding aircraft flight deck and automotive bodywork.

The present invention relates to a pneumatic micro sanding machine deprived of any sanding disc, which scrapes using an air cushion effect loaded with abrasive powder. This hand-held tool enables to sand particularly delicate supports such the skin epiderm, thin polychromies, very fragile sculptures and any types of more or less fragile supports.

According to preferred embodiments of the tool of the invention, one and/or the other of the following arrangements is(are) used:
the multiple acceleration conduits of the nozzles of the powder projection ports are replaced with a general common conduit of nozzle;
the jet of the compressed air and abrasive powder projection nozzle is burst by a anti-splash cone; the latter is designed for modifying the exit angle of the jet exiting the acceleration channel of the nozzle in order to direct it towards the ejection members, such as holes or slots which are situated in the disc or rotary platen;
the multiple holes or slots for ejecting the abrasive powder are provided advantageously by drilling, straight or tilted and of a material resistant to the wear caused by the ejection of the abrasive, such as for instance tungsten carbide; the thickness of each washer or board ranges between 1 and 5 millimetres, and said washer(s) is(are) fixed in more or less large number, straight or slightly tilted on the disc or platen closing the nozzle;
the disc or platen which contains the washers or the boards drilled with thin orifices is driven at very high rotational speeds;
the ejection holes in the washers or the boards are thin in diameter, ranging between 10 micrometres and 4 millimetres;
the slots drilled in the boards are several millimetre or several ten millimetre long and have a thin width ranging between 10 micrometres and 4 millimetres;
the amount of washers or of boards inserted in the Teflon disc is multiple, and so is the number of ejection ports drilled in these members made of material resistant to abrasion wear.
the thickness of the washers or boards ranges between 1 and 5 millimetres;
the disc or platen (24) is over all its surface, the ejection member of small thickness, of material resistant to the wear caused by abrasion, and drilled with multiple very thin ejection ports;
the disc or platen which supports the washers or boards has a diameter ranging between 4 millimetres and 250 millimetres;
the disc or platen is fitted with a felt or rubber washer used for dampening the contact of the tool on the support to be sanded in case of contact work or very close work;
the fixed parts receiving the air-abrasive mixture and the rotary parts are mounted within a casing, which casing is screwed on a motor or a hand-held tool such as a pneumatic sanding machine or grinding machine;
the central axis of a pneumatic motor with angle transmission or of a pneumatic motor is used as a nozzle or as a narrow channel for letting through the compressed air and the abrasive of size distribution smaller than 200 micrometres;
the pneumatic tool includes a abrasive powder diffuser which enables to limit the powder flow rate within one gram, said diffuser is in the form of a mini-vessel filled with abrasives, said mini-vessel is fitted in the flow portion with a very small flexible tube easy to tighten, to enable very thin and very accurate dosage of the powder within one gram. This flexible small tube which is very supple under the effect of compressed air will act as a vibrator, for easier flow of the abrasive. Wherein this mini-vessel may be fitted with a small pneumatic jack or a blow nozzle for draining sequentially the flow zone;
A control button situated on the tool enables to open and to close automatically the supply of the abrasive, which enables to fraction sequentially, this supply of abrasive and to circulate throughout the rest of the time simply air, in the ducts and the ejection ports, in order to drain them.
the rotational axis of the disc acting in its centre as a nozzle acceleration conduit and which is already fitted on its outer face with two watertight bearings serves directly as a pneumatic motor, the nozzle will serve on its external face as a rotor and will be fitted with 5 thin blades, a front flange and a rear flange, the assembly will be fitted with a double-wall cylinder drilled with several holes letting through dry and clean compressed air coming from a pneumatic compressor and used for rotating the rotary portion of the tool;
the tool comprises a suction system operating close to the working head for sucking in the residues in the annulus separating the latter from the wall of the gun, toward an evacuation conduit, said suction system including means for injecting compressed air at high speed through an annular clearance of very small width, situated directly on the projection tool, for sucking the dusts in; the compressed air injected through the annulus for sucking in the dusts generated may advantageously come from the exhaust of the pneumatic motor;
the multiple holes or slots for ejecting the abrasive are drilled in a washer or a board made of tungsten carbide or any other material resistant to the wear caused by the ejection of abrasives, and whereof the thickness of this washer or board ranges between 1 and 5 millimetres and that one or several of these washers or boards made of tungsten carbide are fixed to a disc, which disc is used for closing the nozzle;
the powder used ranges between 1 and 200 micrometres and this size distribution is calibrated extremely well by steps of 10 microns;
the extreme thinness of the projection ports is obtained by assembling two semi-washers or boards made of tungsten carbide;
the disc is equipped with means such as a self-clamping chuck enabling to fix or remove rapidly the disc or the platen in order to change it and thus adapt different types of disc or platen, of more or less great diameter and having more or less thin ejection ports.
the disc or platen is also fitted in its centre or at the periphery with an eccentric provided to exert an automatic movement enabling the tool during the scraping operation, to slide over the support to be sanded;

The device of the invention includes upstream a compressor which provides dry and clean compressed air. The working pressure provided by the compressor ranges between 1 and 10 bars. For certain types of works, due to the features of the present invention, this pressure may even be greater than 10 bars, event reach 20 or 25 bars for hard or relatively hard supports.

Other features and advantages of the invention will appear using the description of different embodiments, given solely by way of example, and represented on the appended drawings wherein:

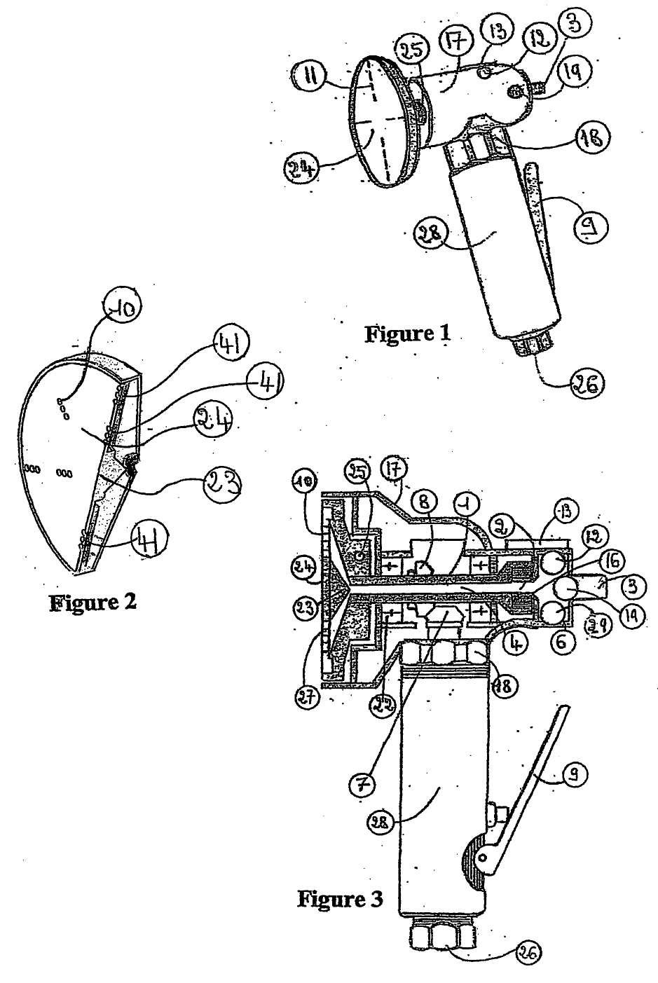

FIG. 1 is a overall perspective view of the sanding tool;

FIG. 2 is a front view of a projection disc or platen fitted with ejection holes and of boards made of tungsten carbide;

FIG. 3 is a diagrammatical sectional view of the sanding tool;

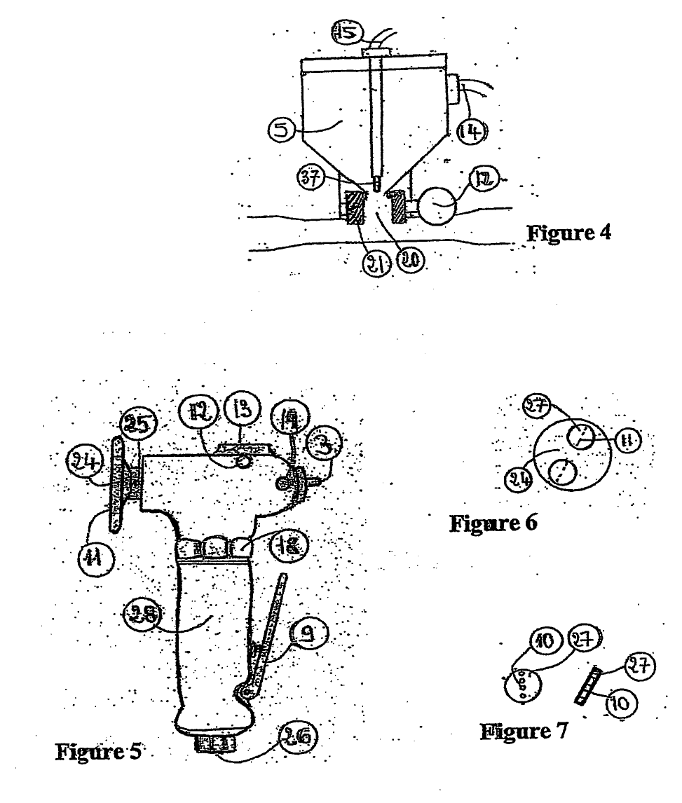

FIG. 4 is a sectional view of a mini-vessel filled with abrasive which may equip the sanding tool;

FIG. 5 is a side view of a tool for cleaning polychromies;

FIG. 6 is a front view of the cleaning disc provided on the tool of FIG. 5;

FIG. 7 is a washer of tungsten carbide drilled with multiple holes, as a front view and a sectional view;

FIG. 8 is a perspective view of a tool for sanding the skin;

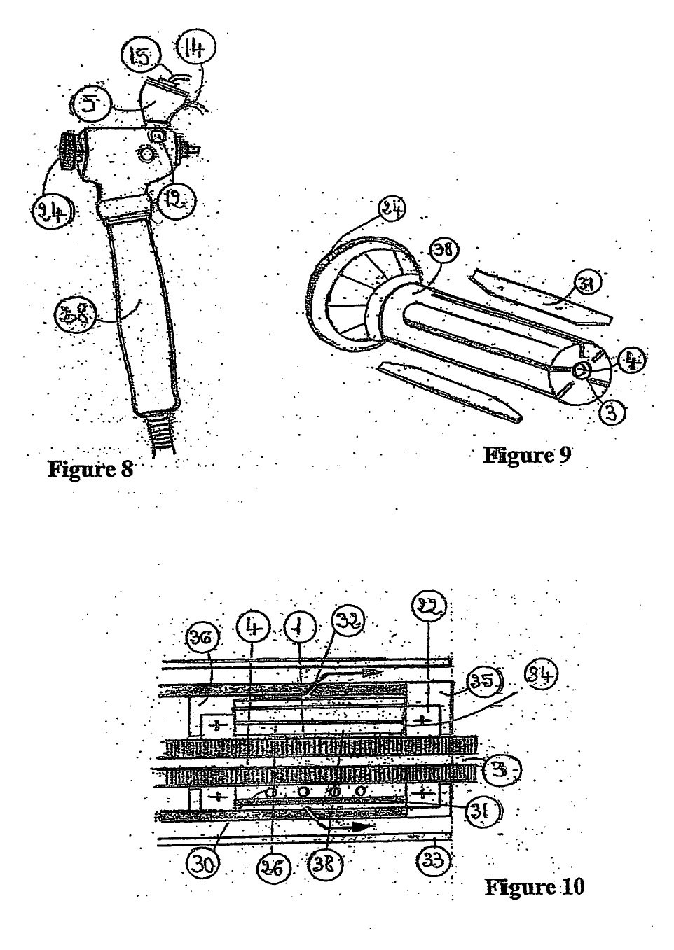

FIG. 9 is a perspective view of a nozzle fitted with blades for rotation;

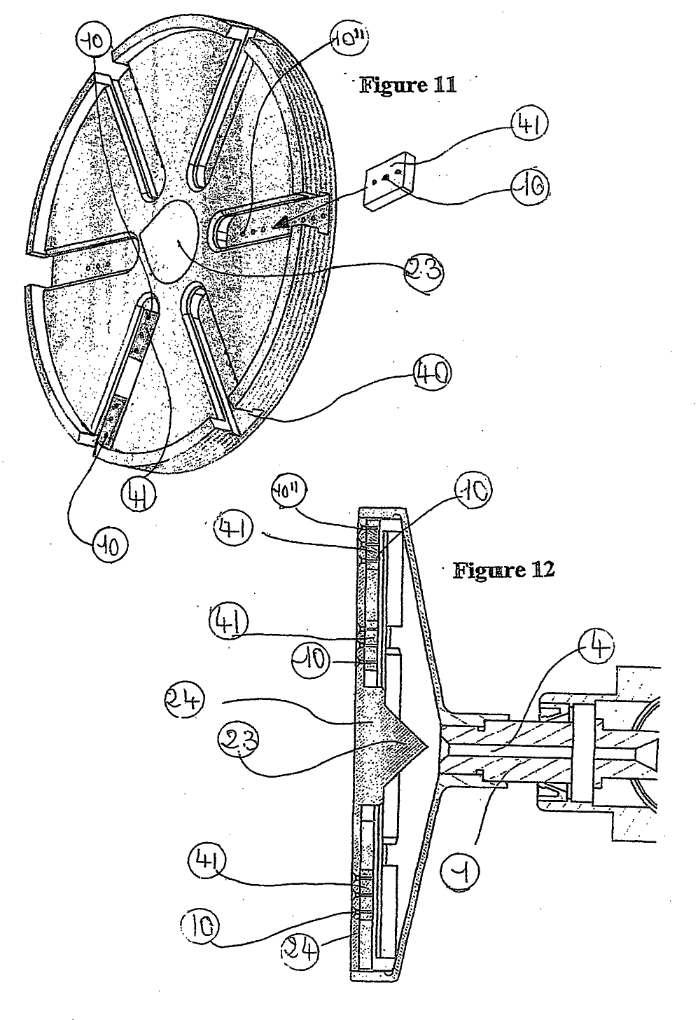

FIG. 10 represents is a sectional view of an assembly composed of a motor and a rotary portion of the sanding tool, and its equipment for the evacuation of the compressed air from the motor which is also used for absorbing the dusts generated by the cleaning operation;

FIG. 11 is a overall perspective view, see for its internal surface, of an disc or platen made of Teflon machined for receiving ejection members made of tungsten carbide, and a view of said ejection member in the form of board to be nested in the machined disc, as well as the positioning of two members nested in their groove, the holes which appear in the machined Teflon cavity have no functions, apart from making invisible the ejection members on the external face side of the disc or rotary platen;

FIG. 12 is a sectional view of the projection platen along FIG. 11, mounted suitably on its support.

The scraping tool according to the invention and FIGS. 1 to 3 includes a casing 17 which accommodates mainly a revolution body 2, so-called rotational axis of the disc or platen acting as an acceleration channel common to all the ejection ports 10 and 11.

This revolution body 1, 2 is mounted on a motor-turbine 28 intended for driving the rotary portion 1 and the platen or disc 24; this motor-turbine 28 also forms a gripping handle de the tool for an operator.

As shown on FIG. 3, the rotary portion 1 de the tool, so-called rotational axis of the disc or platen includes in its centre a nozzle conduit, so-called acceleration channel 4 common to all the exhaust ports, such as holes 10 and slots 11 whereof the upstream end is connected to a pressurised air supply fixed portion 3 loaded or not with abrasive, and the opposite downstream end emerges at a space closed by a disc or platen 24.

This disc or platen 24 is equipped with several boards 41 made of tungsten carbide of a thickness de 3 millimetres and drilled with several very thin holes 10 of the order of 500 micrometres.

The downstream end of the acceleration channel 4 emerges on an anti-splash cone 23; this anti-splash cone 23 extends coaxially to said channel 4 and is situated in the centre of the internal surface of the disc or platen 24.

The acceleration duct 4 has a section of approximately 3 millimetres and a length of 7 millimetres. The disc or platen 24 has on FIG. 1 a diameter of 8 centimetres.

On FIG. 1 the disc or platen 24 is drilled with numerous slots. These ejection ports have advantageously a width of 300 micrometres for a length of 2 millimetres. These slots 11 are distributed along two lines, arranged according to a general X-shape.

The motor-turbine at high speed 28 mentioned above is integral with the casing 17 by screwing means 18 (FIG. 3). This motor-turbine 28 drives in rotation the revolution body 1 and the disc or platen 24 by means of a pinion, as for a motor fitted with an angle transmission. The casing 17 includes means 13 for receiving a small abrasive tank, mini-vessel 5.

Generally speaking, for scraping the epiderm, the use of this small abrasive tank, mini-vessel 5 enables to sterilise the abrasive. These powder mini-vessels are in the form of small vials.

The abrasive can be calibrated within 10-micrometre granulometric ranges. For instance, the mini-vessels 5 may be used by categories of ranges with accurate size distribution: for instance, a vial of powder ranging between 10 and 20 micrometres, etc.

As shown on FIG. 8, the mini-vessel 5 is arranged directly on the gun by screwing, enabling its quick replacement once empty; alternately, this mini-vessel 5 can be offset in immediate vicinity of the operator or controlled remotely from a control cabinet.

This mini-vessel 5 as on FIG. 4 contains abrasive powder.

The powder contained in the mini-vessel 5 descends by gravity via a conduit 20 wherein a hollow plastic joining piece 21 can be found; a compressed air supply 14 pressurises the vessel; which promotes the flow of the power through the conduit 20; when compressed air flows beneath, it mixes with a little abrasive powder.

A small pneumatic jack 15 is also provided to prevent said plastic tube 21 from being clogged, for sequentially manoeuvring in translation a stem 37 situated at the plastic tube 21, in order to clear it, if needed.

With reference to these drawings:

En practice, while pressing on the joystick (9), the compressed air arrives through the joining piece (26) in the motor (28), which then drives the rotational axis 1 driving in rotation the disc or platen 24.

Opening a button (19) enables to adjust the opening or the closing of the compressed air supply in the tool, and consequently the flow rate of air projected. The compressed air arrives directly from the compressor in the gun via the joining piece (3). The compressed air arrives therefore in the sanding gun via the joining piece (3) without being loaded with abrasives.

When the mini-vessel is on the tool, by opening the button (12) the abrasive contained in the vessel (5) descend through the channel (20). Acting on this button (12) enables to adjust volume of abrasive arriving, which enables to modulate within one gram the dosage of abrasives in compressed air. This is in particular possible since the abrasive flows through the small flexible and hollow plastic conduit 21, floating and vibrating at the channel 20. The small tube (21) may hence be tightened by the screw (12) up to the thinnest possible adjustment; this also enables while closing completely the screw (12) to purge at all times the conduits while leaving to circulate in the channel (4) and the ejection ports 10 and 11 only dry and clean air coming from the joining piece (3).

The mixture composed of pressurised air/abrasive particles is then accelerated throughout the acceleration channel 4 up to reaching into the closed space, where the anti-splash cone 23 ensures the orientation therefore towards the ejection ports, simple holes 10 or slots 11. These ports, when these are holes, have a preferential diameter of the order of 500 micrometres.

The disc or platen 24, driven by the mini-turbine at high speed, rotates at speeds vastly greater than 500 revolutions per minute; most often these speeds are close to 2000 to 20,000 revolutions per minute. In certain cases, these speeds of the disc or platen 24 exceed 30,000 revolutions per minute. The compressed air jets are thus driven into rotation, at the same speed as that of the disc or platen 24.

The apparatus is then applied most often a few millimetres away from the surface to be treated, sometimes almost by contact; at such a distance, the sanding operation is performed as if the sanding machine had a compressed air disc wherein abrasive powders are floating. When the operator wishes to stop his intervention, he only needs to close first the supply button (12) of abrasive particles, then the pressurised air supply button (19) and then to release the joystick (9), corresponding to the air supply into the motor.

Advantageously, it is possible:
To diffuse sequentially solely compressed air into the tool, so as to drain more or less regularly the acceleration channel of the nozzle (4) and the ejection ports (10 and 11);
to equip the tool with a pneumatic selective master valve with separate control and operating optionally sequentially; in such a context, a pneumatic selective valve for instance may be used for supplying air into the motor 28, a pneumatic selective valve for supplying air through the joining piece 3, a pneumatic valve operates the opening and the closing of the abrasive valve 20.

FIG. 5 shows the sanding tool adapted in particular for processing smears on polychromies. This tool is similar to that described below in relation with FIGS. 1 to 3, and differentiates itself solely and mainly by the diameter of its disc or platen 24. This disc or platen 24, represented in particular on FIG. 6, has a diameter of 30 to millimetres. This disc or platen 24, made of Teflon type material includes two cylindrical though-housings within each of which is inserted a washer 27, fitted with a plurality of slots 11, here four in number. These washers 27 are made of tungsten carbide, to sustain the loads induced by the abrasion of the particles when exiting through the orifices 11. These washers have a diameter of 12 millimetres for a thickness of 2 millimetres.

FIG. 7 shows an embodiment variation of the washers made of tungsten carbide 27, which are here equipped of a plurality of aligned cylindrical through-holes 10. These ejection holes 10 have a diameter most often ranging between 10 and 500 micrometres. Generally speaking, the washers 27 described above in relation with FIGS. 5 to 7, may be added within patens of different diameters which are more or less large. This diameter varies from 4 millimetres to 250 millimetres. The number of washers, and the number of their orifices, are then adapted in more or less large number according to the effect requested.

The tool represented on FIG. 8 is adapted for dermatologic treatments of microdermabrasion. To do so, the corresponding tool differentiates from that described in relation with FIGS. 1 to 3 solely, by the diameter of the acceleration channel of nozzle (4), which has a 1-millimetre diameter. The very small diameter of this channel, which is also the rotational axis of the disc or platen, enables the manufacture of a very compact tool. The ejection ports situated on the disc are eight in number and have a 300 micrometres diameter.

FIG. 9 shows an embodiment variation relating to the mobile portion 1 of the revolution body, which reconstitutes here a pneumatic motor. In such a case, the acceleration channel 4 of the mobile portion 1 acts as a rotor 38, and is fitted with five thin blades 31. Front 36 and rear 35 flanges are provided at each of the ends of the rotor 38. This motor 33 is still fitted with a double-wall cylinder 34 drilled with several openings 30 letting through dry and clean compressed air. The purpose of the assembly is to drive in rotation the disc or platen 24, while conveying in its centre 4 the air-powder mixture.

FIG. 10 shows a suction principle for sucking in the light dusts generated. The presence of an annular clearance 32 can be noted, small in width, through which air is injected at high speed so as to suck in the dusts by a Venturi effect. This air flow is due advantageously from the exhaust of the pneumatic motor 28.

The realisation of the disc or platen 24 is represented on FIGS. 11 and 12. This platen includes means 40 for inserting boards made of tungsten carbide 41. In such a case, the disc or platen 24 is made of Teflon, includes six housings 40, provided on its internal surface side. The housings 40 in question are general elongated in shape, they extend each in a radiating fashion between the central anti-splash cone 23 and the peripheral rim of disc or platen 24; these housings are spread regularly around the anti-splash cone 23. These housings 40 in question are each shaped for receiving and holding one or several boards made of tungsten carbide 41, in the form of a tab, of board or of flat. The housings 40 have a constant section over their whole length. They are machined in the form of a T for receiving and blocking the tabs, boards or flats. The tabs, boards or flats 41 are made if a material such as tungsten carbide, and exhibit corresponding space requirements identical to those of their housings 40 to be forcibly inserted. These tabs, or flats 41, which are called boards 41 are 3 millimetres thick, 12 millimetres long and 10 millimetres wide. They are fitted with orifices 10, in the form of through-holes. Once in position within its housing 40, the board 41 which is invisible externally is positioned judiciously so as to match the holes 10″ drilled in the disc or platen made of Teflon 24. The function of this drilling principle of the disc or platen 24 only consists in making the tungsten carbide boards non visible from the external side of the disc. In practice, the platen 24 in question is screwed on the rotary portion 43. The disc or platen 24 assembly thus set up may equip all the tools of the invention.

Still on FIG. 11, the pressurised air-powder mixture is projected against the anti-splash cone 23, ensuring the distribution thereof on the internal surface of the platen 24. The air-powder mixture thus reaches the flats 41, and runs through the ejection ports made of tungsten carbide 10 of the platen 24 to generate the sanding abrasive strength, said platen 24 being driven into rotation in parallel at very high speeds, speeds of the order of 1000 to 30,000 revolutions per minute.

1. A pneumatic sanding machine for cleaning and scraping characterised in that the disc or rotary platen (24) fitting this sanding tool has one or several members (27, 41) of small thickness, drilled with more or less great a number of ejection ports, which may even be simple holes (10) or simple slots (11), said holes (10) or slots (11) being in charge of evacuating, after bursting against a anti-splash cone (23), a mixture of compressed air and powder coming from at least one nozzle acceleration duct (1, 4) and in that said disc or platen (24) which includes these ejection members (27, 41) is driven into rotation at very high speeds, these speeds are greater than 100 revolutions per minute, ranging between 1,000 and 20,000 revolutions per minute, and liable even to exceed 30,000 revolutions per minute, but ranging generally between 4,000 and 12,000 revolutions per minute.

2. A pneumatic tool according to claim 1 characterised in that the very high rotational speeds of the platen or disc (24) comprising the ejection members (27, 41) are obtained using a mini-turbine, of pneumatic motor type.

3. A pneumatic tool according to claim 1, characterised in that the multiple holes (10) or slots (11) for ejecting the abrasive are provided, over at least a portion of their thickness, in a member (27, 41) of material resistant to the wear caused by the ejection of abrasive substances, the thickness of said member ranging between 100 micrometres and 5 millimetres, said member(s) (27, 41) being fastened to the disc or the like (24) closing the nozzle (1).

4. A pneumatic tool according to claim 1, characterised in that the member including the ejection ports of hole or slot type enabling to eject the abrasive is in the form of a washer (27), of a tab, of a board or of a flat (41) of material resistant to the wear caused by abrasion, such as tungsten carbide.

5. A pneumatic tool according to claim 1, characterised in that the disc (24) is fitted with members (27, 41), which members (27, 41), are drilled with one or several holes or slots extending forward or tilted, said members (27, 41) are arranged more or less in a large number, forward or slightly tilted, within the disc (24).

6. A pneumatic tool according to claim 4 characterised in that the extreme thinness of the projection orifices may be obtained by assembling two portions of tungsten carbide or of any other abrasion wear resistant material.

7. A pneumatic tool according to claim 1 characterised in that the holes in the ejection member (10) are multiple and have a diameter ranging between 10 micrometres and 4 millimetres.

8. A pneumatic tool according to claim 1, characterised in that the slots in the ejection member (11) are multiple and have a width ranging between 10 micrometres and 2 millimetres, for a length of 1 millimetre to several centimetres.

9. A pneumatic tool according to claim 1, characterised in that the disc or platen (24) is machined for receiving ejection members (41, 27), of small thickness, which are inserted by nesting in said platen or disc (24).

10. A pneumatic tool according to claim 1, characterised in that the disc or platen (24) is over all its surface, the ejection member of small thickness, of material resistant to abrasion wear, and drilled with very thin ejection ports.

11. A pneumatic tool according to claim 13, characterised in that a casing (17), screwed on a manual tool set (28) such as a pneumatic sanding machine or grinding machine, contains in its centre, at its axis of rotation, at least one nozzle acceleration duct (1,4)

12. A pneumatic tool according to claim 1, characterised in that a control button situated on the sanding tool enables to open and to close automatically the supply of the abrasive, which enables to fraction sequentially, this supply of abrasive and to circulate throughout the rest of the time simply air, in the ducts and the ejection ports, in order to drain them.

13. A pneumatic tool according to claim 1, characterised in that the size distribution of the powder used ranges between 1 and 200 micrometres and that this size distribution is calibrated extremely well by steps of 10 microns.

14. A pneumatic tool according to claim 1, characterised in that the tool is connected to a mini-vessel including powder and that for limiting with one gram accuracy the powder flow rate, this mini-vessel includes in the flow zone an easy-to-tighten flexible plastic tube, to enable very thin and very accurate dosage; and in that this very flexible small tube under the effect of the circulation of compressed air acts as a vibrator, for easier flow of the abrasive; this mini-vessel is also fitted with means enabling to drain the flow zone from the powder.

15. A pneumatic tool according to claim 1, characterised in that it comprises a suction system operating close to the working head for sucking in the residues in the annulus space separating the latter from the wall of the gun, toward an evacuation conduit, characterised in that said suction system includes means for injecting compressed air at high speed through an annular clearance (32) of small width, situated directly on the projection tool, for sucking the dusts in.

16. A pneumatic tool according to claim 1, characterised in that the disc or platen (24) includes for sucking in the dusts produced, plastic or aluminium vanes connected directly to a small vacuum bag or connected to a second, more remote suction source, such as an industrial centrifugal vacuum cleaner.

17. A pneumatic tool according to claim 1, characterised in that the fixed portion (2) and the rotary portion (1) includes one or several rotary joints (16).

18. A pneumatic tool according to claim 1, characterised in that the nozzle (1) fitted with two watertight bearings (22) may serve directly as a pneumatic motor; the thickness of the nozzle (1) acting as a rotor (38) and being fitted with five thin blades (31), with a front flange (36) and a rear flange (35). the assembly being fitted with a double-wall cylinder (34) drilled with several openings (30) letting through the dry and clean compressed air coming from a pneumatic compressor and used for rotating the nozzle (1) and the disc (24).

19. A pneumatic tool according to claim 1, characterised in that the disc or platen (24) is fitted with a felt or rubber washer used for dampening the contact of the tool on the support to be sanded in case of very close work.

20. A pneumatic tool according to claim 1, characterised in that the disc or platen (24) is also fitted in its centre or at the periphery with an eccentric provided to exert an automatic movement enabling the tool during the scraping operation, to slide on the support to be sanded.

21. A pneumatic tool according to claim 1 characterised in that the disc (24) is equipped with means such as a self-clamping chuck (25) enabling to attach or remove rapidly the disc or the platen (24) in order to change it and thus adapt different types of disc or platen (24), of more or less great diameter and having more or less thin ejection ports.

22. A pneumatic tool according to claim 1, characterised in that the multiple acceleration conduits of the nozzles are replaced with a general common conduit of nozzle (1), called acceleration duct (4)

23. A pneumatic tool according to claim 1, characterised in that the disc or platen of the tool (24) exhibits a diameter ranging between 4 millimetres and 250 millimetres.
